(19) United States
(12) Patent Application Publication
(10) Pub. No.: US 2008/0253830 A1
(43) Pub. Date: Oct. 16, 2008

(54) Method of Installing Anchor Bolt, Method of Drilling Anchor Bolt Hole, and Drilling Device

(76) Inventor: Akio Katsuki, Fukuoka (JP)

Correspondence Address: Kazunao Kubotera;TAKEUCHI & KUBOTERA, 200 Daingerfield Road, Suite 202, Alexandria, VA, 22314, US

(21) Appl. No.: 10/591,988

(22) PCT Filed: Mar. 30, 2005
(86) PCT No.: PCT/JP2005/006166

§ 371 Date: Jun. 19, 2008

(30) Foreign Application Priority Data
Mar. 31, 2004 (JP) 2004-107733

(51) Int. Cl. E02D 5/80; E04G 23/02; E04G 21/12; F16B 39/00; B23B 51/00

(52) U.S. Cl. 403/24; 411/107; 408/171; 408/153

(57) ABSTRACT

An object of the present invention is to install an anchor bolt with sufficient strength without lowering strength even when a reinforcing member exists. According to the present invention, in a method of installing an anchor bolt in a fixing surface, first, a first fixing hole for fixing the anchor bolt is drilled in the fixing surface. Then, a second fixing hole is drilled from a distal end portion of the first fixing hole in an inclined state. Afterward, an anchor bolt bent at a middle portion thereof is fixed to the first fixing hole and the second fixing hole.

### TECHNICAL FIELD

The present invention relates to a method of installing an anchor bolt, a method of drilling an anchor bolt hole, and a drilling device.

### BACKGROUND OF THE INVENTION

Conventionally, when an anchor bolt is installed in an existing structure for reinforcement or expansion, a drilling device is used for drilling a fixing hole in a fixing surface for installing the anchor bolt, so that the anchor bolt is inserted into the fixing hole (refer to Patent Reference 1).

In particular, when a reinforcing member is installed inside a fixing surface of an existing structure, first, it is tried to find a location where a reinforcing member does not exist according to a previous construction drawing. Then, a radio-wave radar detector is used for confirming that a reinforcing member does not exist. Afterward, a drilling device is used for drilling a fixing hole in the location.

In the conventional method of installing an anchor bolt, a radio-wave radar detector can detect only a depth of 100 to 140 mm. Accordingly, when there is no previous construction drawing, or a reinforcing member does not exist at a location drawn in a construction drawing, there may be a chance of hitting an existing reinforcing member during an actual operation of drilling a fixing hole of an anchor bolt.

In this case, a fixing hole must be drilled at a different location, or a short anchor bolt is fixed to a shallow fixing hole. Alternatively, an existing reinforcing member is cut, so that a deep fixing hole is drilled.

However, when a fixing hole is drilled at a different location, an anchor bolt may not have sufficient strength. When an existing reinforcing member is cut and a deep fixing hole is drilled, a fixing surface may have lowered strength. If these problems are left as is, it is possible to cause a serious social issue.

To this end, through keen study, the inventor has been able to develop the present invention. According to the present invention, it is possible to install an anchor bolt with sufficient strength without lowering strength even when a reinforcing member exists.
Patent Reference 1: Japanese Patent Publication No. 11-131999

### DISCLOSURE OF THE INVENTION

According to claim 1 of the present invention, in a method of installing an anchor bolt in a fixing surface, first, a first fixing hole for fixing the anchor bolt is drilled in the fixing surface. Then, a second fixing hole is drilled from a distal end portion of the first fixing hole in an inclined state. Afterward, an anchor bolt bent at a middle portion thereof is fixed to the first fixing hole and the second fixing hole.

According to claim 2 of the present invention, in a method of installing an anchor bolt in a fixing surface, first, a first fixing hole for fixing the anchor bolt is drilled in the fixing surface. Then, a plurality of second fixing holes is drilled from a distal end portion of the first fixing hole in an inclined state. Afterward, an anchor bolt having a plurality of branched portions at a middle portion thereof is fixed to the first fixing hole and the second fixing holes.

According to claim 3 of the present invention, in claim 1 or claim 2 of the present invention, the first fixing hole is drilled with a first drilling bit detachably attached to a distal end of a first drilling tool. Then, the first drilling bit at the distal end of the first drilling tool is replaced with a guide bush. A second drilling tool is inserted through a guide hole formed in the guide bush in an inclined state. Lastly, the second fixing hole is drilled with a second drilling bit detachably attached to a distal end of the second drilling tool.

According to claim 4 of the present invention described, in claim 2 or claim 3 of the present invention, at least one of the plurality of the second fixing holes is drilled to penetrate through an existing reinforcing member installed inside the fixing surface.

According to claim 5 of the present invention described, in any one of claim 2 to claim 4 of the present invention, the plurality of the branched portions of the anchor bolt is formed of a shape-memory alloy, so that a distal end portion of the anchor bolt can open and close according to a temperature change.

According to claim 6 of the present invention, in a method of drilling a fixing hole for fixing an anchor bolt in a fixing surface, first, a first fixing hole is drilled in the fixing surface. Then, a plurality of second fixing holes is drilled from a distal end portion of the first fixing hole in an inclined state.

According to claim 7 of the present invention, in claim 6 of the present invention, the first fixing hole is drilled with a first drilling bit detachably attached to a distal end of a first drilling tool. Then, the first drilling bit at the distal end of the first drilling tool is replaced with a guide bush. A second drilling tool is inserted through a guide hole formed in the guide bush in an inclined state. The second fixing holes are drilled with the second drilling bit detachably attached to a distal end of the second drilling tool.

According to claim 8 of the present invention described, in claim 6 or claim 7 of the present invention, at least one of the plurality of the second fixing holes is drilled to penetrate through an existing reinforcing member installed inside the fixing surface.

According to claim 9 of the present invention, in a drilling device for drilling a fixing hole for fixing an anchor bolt in a fixing surface, the drilling device includes a first drilling tool; a first drilling bit detachably attached to a distal end of the first drilling tool; a guide bush detachably attached to the distal end of the first drilling tool; a second drilling tool to be inserted through a guide hole formed in the guide bush in an inclined state, and having a diameter smaller than that of the first drilling tool; and a second drilling bit detachably attached to a distal end of the second drilling tool.

According to claim 10 of the present invention, in claim 9 of the present invention, the second drilling bit includes a guide portion on an outer circumference surface thereof having a height same as that of a grinding stone.

### BRIEF EXPLANATION OF THE DRAWINGS

FIG. 1 is a side sectional view showing a drilling device according to the present invention;

FIG. 2 are a side view (a) and a plan view (b) showing a first drilling bit;

FIG. 3 are a side view (a) and a plan view (b) showing a second drilling bit;

FIG. 4 is a side view showing an anchor bolt;

FIG. 5 is a side view showing an anchor bolt;

FIG. 6 is a side view showing an anchor bolt;

FIG. 7 is a side view showing an anchor bolt;

FIG. 8 is a side view showing an anchor bolt;

FIG. 9 is a side view showing an anchor bolt;

FIG. 10 is a side view showing an anchor bolt;

FIG. 11 is a side sectional view showing a method of drilling a first fixing hole and a second fixing hole;

FIG. 12 is a side sectional view showing the method of drilling the first fixing hole and the second fixing hole;

FIG. 13 is a side sectional view showing the method of drilling the first fixing hole and the second fixing hole;

FIG. 14 is a side sectional view showing the method of drilling the first fixing hole and the second fixing hole;

FIG. 15 is a side sectional view showing the method of drilling the first fixing hole and the second fixing hole;

FIG. 16 is a side sectional view showing the method of drilling the first fixing hole and the second fixing hole;

FIG. 17 is a side sectional view showing the method of drilling the first fixing hole and the second fixing hole;

FIG. 18 is a side sectional view showing the method of drilling the first fixing hole and the second fixing hole;

FIG. 19 is a side sectional view showing the method of drilling the first fixing hole and the second fixing hole;

FIG. 20 are a side view (a) and a plan view (b) showing a second drilling bit;

FIG. 21 is a side view showing an anchor bolt;

FIG. 22 are a side sectional view (a) and a plan view (b) showing a method of drilling a first fixing hole; and

FIG. 23 is a side sectional view showing the method of drilling the first fixing hole.

### EMBODIMENTS OF THE INVENTION

According to the present invention, a fixing hole is drilled in a fixing surface of a structure for fixing an anchor bolt. Afterward, the anchor bolt is inserted into the fixing hole.

According to the present invention, after it is tried to find a location where a reinforcing member does not exist according to a previous construction drawing, a radio-wave radar detector is used for confirming that a reinforcing member actually does not exist. Then, a first fixing hole is drilled at the location with a drilling device. When a reinforcing member exists in front of the first fixing hole, a second fixing hole is drilled from a distal end portion of the first fixing hole in an inclined state. Afterward, an anchor bolt having a bending portion at a middle portion thereof is fixed into the first fixing hole and the second fixing hole.

In this case, the second fixing hole may have a diameter same as that of the first fixing hole, or may include a plurality of fixing holes having a diameter smaller than that of the first fixing hole.

In drilling the first fixing hole and the second fixing hole, first, the first fixing hole is drilled with a first drilling tool. Afterward, the second fixing hole is drilled from the distal end portion of the first fixing hole in an inclined state with a second drilling tool.

In this case, the first fixing hole may be drilled with a first drilling bit detachably attached to a distal end of the first drilling tool. Then, the first drilling bit at the distal end of the first drilling tool is replaced with a guide bush. The second drilling tool is inserted through a guide hole formed in the guide bush in an inclined state. The second fixing hole is drilled with a second drilling bit detachably attached to a distal end of the second drilling tool.

At least one of a plurality of the second fixing holes may be drilled to penetrate through an existing reinforcing member installed inside the fixing surface.

As the anchor bolt to be fixed to the first fixing hole and second fixing hole, the anchor bolt may have a plurality of distal end portions branched from a middle portion thereof and formed of a shape-memory alloy. Accordingly, the distal end portions can open and close according to a temperature change. A material of the anchor bolt is not limited to a shape-memory alloy, and may include a normal anchor bolt material. Especially when the anchor bolt having the branched distal end portions has a small diameter, a normal anchor bolt material may be used.

As described above, according to the present invention, after the first fixing hole for fixing the anchor bolt is drilled in the fixing surface, the second fixing hole is drilled from the distal end portion of the first fixing hole in an inclined state. Accordingly, even when an existing reinforcing member is installed inside the fixing surface, it is possible to drill the second fixing hole diverting the existing reinforcing member or penetrating through the existing reinforcing member.

Further, it is possible to fix the anchor bolt having a plurality of branched portions in an octopus-leg shape at the middle portion thereof in the first fixing hole and the second fixing hole, thereby securely obtaining sufficient strength of a structure and sufficient strength of the anchor bolt.

Hereunder, embodiments of the present invention will be explained with reference to the accompanying drawings.

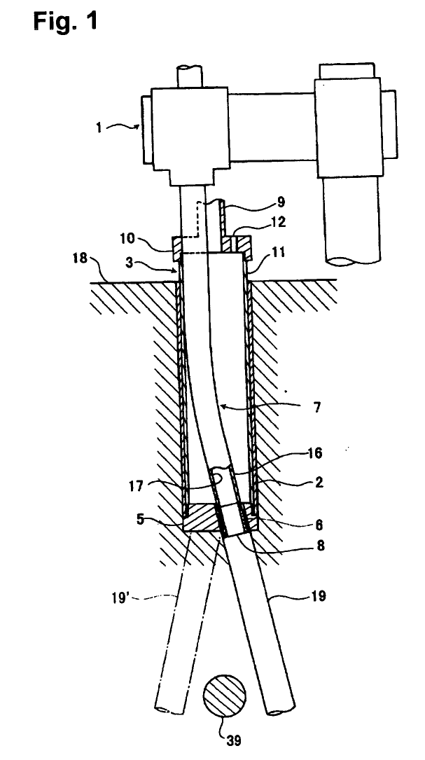

The drilling device according to the present invention will be explained first. As shown in FIGS. 1 to 3, a drilling device 1 includes a first drilling tool 3 for drilling a first fixing hole 2; a first drilling bit 4 detachably attached to a distal end of the first drilling tool 3; a guide bush 5 detachably attached to the distal end of the first drilling tool 3; a second drilling tool 7 to be inserted through a guide hole 6 formed in the guide bush 5 in an inclined state, and having a diameter smaller than that of the first drilling tool 5; and a second drilling bit 8 detachably attached to a distal end of the second drilling tool 7.

In the first drilling tool 3, a holder 10 is attached to a distal end of a drive shaft 9 connected to a rotational drive device. An outer tube 11 having a hollow cylindrical shape is attached to a lower portion of the holder 10. The first drilling bit 4 and the guide bush 5 are detachably screwed and attached to a distal end of the outer tube 11.

In the first drilling tool 3, a through hole 12 is formed in the holder 10, so that cooling liquid can be poured in through the through hole 12.

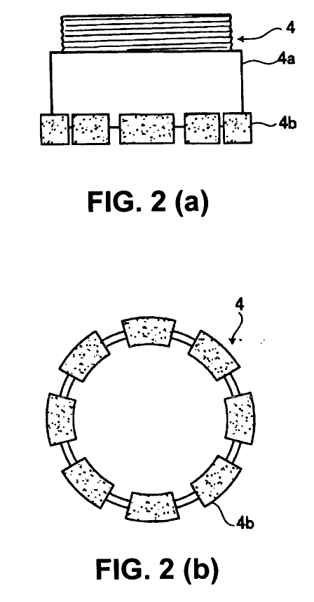

As shown in FIG. 2, in the first drilling bit 4, segment grinding stones 4b arranged in a circular shape are attached to an outer circumference of a bit main body 4a attached to the distal end of the outer tube 11.

The guide bush 5 is provided with the guide hole 6 formed in a main body thereof having a cylindrical shape in a state inclined from a center axis of the outer tube 11 toward outside.

In the second drilling tool 7, the second drilling bit 8 is detachably screwed and attached to a distal end of an inner tube 16 having flexibility. The inner tube 16 has a hollow cylindrical shape and a diameter smaller than that of the outer tube 11 of the first drilling tool 3. The inner tube 16 is connected to a rotational drive device.

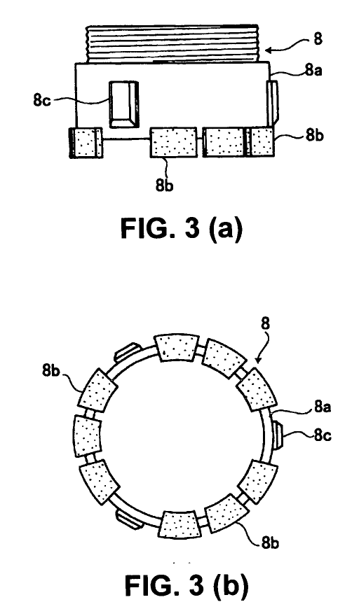

As shown in FIG. 3, in the second drilling bit 8, segment grinding stones 8b are attached with an interval along a circumferential direction to an outer circumference of a bit main body 8a attached to the distal end of the inner tube 16. Further, guide members 8c with a convex shape having a height same as that of the segment grinding stones 8b are attached to the outer circumference with an interval along a circumferential direction. The guide members 8c with a convex shape prevent the second drilling bit 8 from grinding the guide hole 6 of the guide bush 5. When the second drilling bit 8 grinds the guide hole 6 of the guide bush 5, it is difficult to determine a traveling direction of the second drilling tool 7. Also, the guide members 8c enable the second drilling bit 8 to advance linearly.

The second drilling tool 7 includes a protrusion 17 at an inner middle portion of the inner tube 16, so that the protrusion 17 cuts a drilled concrete core having a small diameter. When a second fixing hole 19 to be drilled has a smaller diameter, the protrusion 17 uses a single blade BTA (Boring and Trepanning Association) type toll or a multiple-cutting-blade BTA type tool as the second drilling bit 8, so that it is possible to drill while grinding and discharging concrete.

A method of drilling with the drilling device 1 described above will be explained next.

First, the first drilling bit 4 is attached to the distal end of the first drilling tool 3. Then, the first drilling tool 3 is driven to rotate, so that the first drilling bit 4 drills the first fixing hole 2 in a fixing surface 18 of a structure.

In the next step, the first drilling tool 3 is temporarily pulled out from the first fixing hole 2, and the first drilling bit 4 is removed from the distal end of the first drilling tool 3. Then, the guide bush 5 is attached to the distal end of the first drilling tool 3, and the second drilling bit 8 at the distal end of the second drilling tool 7 is inserted into the guide hole 6 of the guide bush 5. In this state, the first drilling tool 3 is inserted into the first fixing hole 2 again.

In the next step, the second drilling tool 7 is driven to rotate, so that the second drilling bit 8 drills the second fixing hole 19. At this time, the second drilling tool 7 advances along the guide hole 6 of the guide bush 5 in an inclined state. Accordingly, the second fixing hole 19 is formed in a state inclined outward relative to the first fixing hole 2.

In the next step, the second drilling tool 7 is pulled out from the second fixing hole 19 to a position where the second drilling bit 8 is retained in the guide hole 6 of the guide bush 5. In this state, the first drilling tool 3 is rotated 180 degrees together with the second drilling tool 7.

In the next step, the second drilling tool 7 is driven to rotate, so that the second drilling bit 8 drills a second fixing hole 19′. At this time, the second drilling tool 7 advances along the guide hole 6 of the guide bush 5 in an inclined state. Accordingly, the second fixing hole 19′ is formed in a state inclined outward relative to the first fixing hole 2.

In the last step, the second drilling tool 7 is pulled out from the second fixing hole 19, and the first drilling tool 3 is pulled out from the first fixing hole 2.

Accordingly, it is possible to drill the hole having the branched portions in the structure with the drilling device 1.

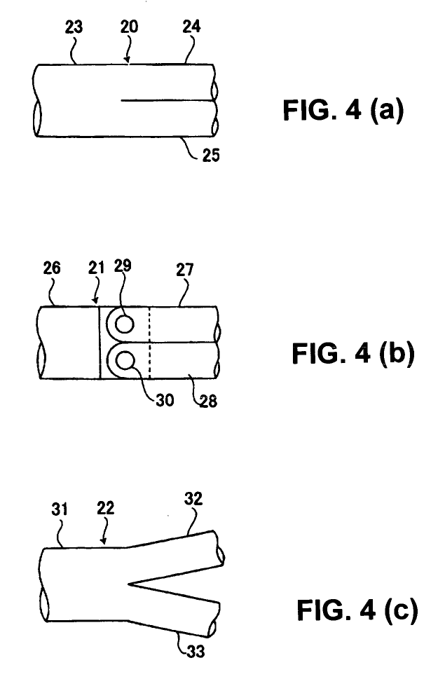

As shown in FIG. 4, anchor bolts 20, 21, and 22 each branched into two portions at a middle portion thereof are inserted into the first and second fixing holes 2 and 19.

The anchor bolt 20 shown in FIG. 4(a) is formed of a shape-memory alloy. Two distal end portions 24 and 25 having a solid-core cylindrical shape are branched from a middle portion of a main body portion 23 having a solid-core cylindrical shape. At a normal temperature, the two distal end portions 24 and 25 closely contact with each other. When heated, the two distal end portions 24 and 25 separate toward outside. Accordingly, the anchor bolt 20 is inserted into the first fixing hole 2 up to a distal end portion thereof at a normal temperature. Then, the anchor bolt 20 is heated, so that the two distal end portions 24 and 25 can be inserted into the second fixing hole 19, respectively.

Since the anchor bolt 20 is formed of a shape-memory alloy, tensile strength thereof becomes about three times higher than normal strength. Accordingly, even after the distal end portion is branched into two, the strength of the anchor bolt 20 is still 1.5 times higher than normal strength.

The anchor bolt 21 shown in FIG. 4(b) is formed of a rigid body such as steel. Two distal end portions 27 and 28 having a solid-core cylindrical shape are branched to freely open and close through joints 29 and 30 from a distal end portion of a main body portion 26 having a solid-core cylindrical shape.

The anchor bolt 22 shown in FIG. 4(c) is formed of a material having flexibility and strength such as carbon fiber. Two distal end portions 27 and 28 having a solid-core cylindrical shape are branched from a middle portion of a main body portion 31 having a solid-core cylindrical shape to freely open and close through joints 29 and 30.

As described above, the anchor bolts 20, 21, and 22 to be inserted into the first and second fixing holes 2 and 19 are branched into a plurality of portions at the middle portions thereof, and are bent at the middle portion thereof. Accordingly, it is possible to increase a pulling out force after being fixed.

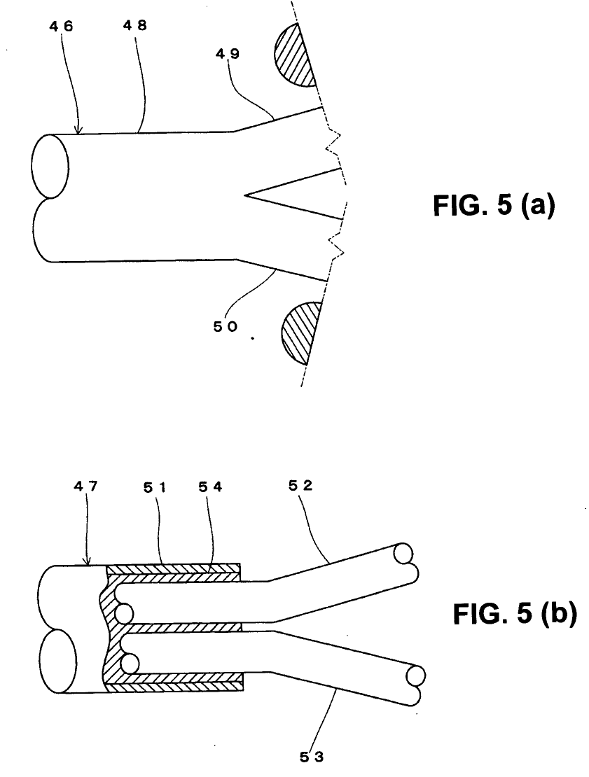

The anchor bolt is not limited to the anchor bolts 20, 21, and 22 shown in FIG. 4, and anchor bolts 46 and 47 shown in FIG. 5 may be used.

The anchor bolt 46 shown in FIG. 5(a) is branched into two distal end portions 49 and 50 having a solid-core semi-circular cylindrical shape from a distal end portion of a main body portion 48 having a solid-core cylindrical shape to freely open and close.

The anchor bolt 47 shown in FIG. 5(b) has two distal end portions 52 and 53 having a solid-core semi-circular cylindrical shape and attached with an adhesive 54 or mechanically connected to an inner portion of a main body portion 51 having a hollow cylindrical shape.

The anchor bolts 20, 21, 22, 46, and 47 shown in FIGS. 4 and 5 have the distal end portions branched into the two portions having a same diameter, and the invention is not limited thereto.

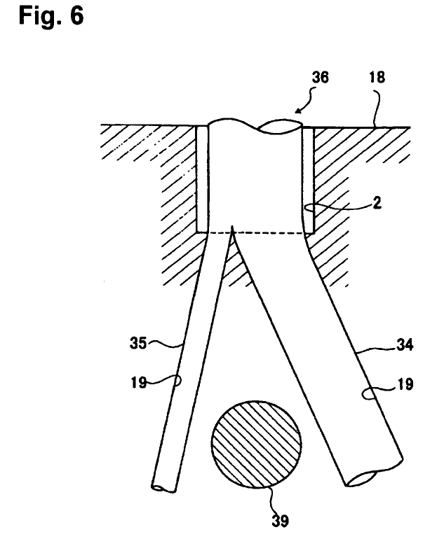

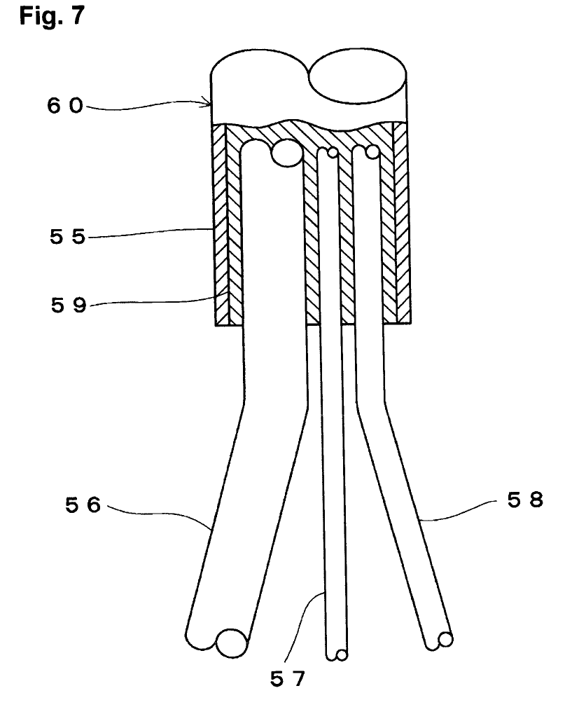

As shown in FIG. 6, an anchor bolt 36 is branched from a middle portion thereof into two distal end portions 34 and 35 having a large diameter and a small diameter, respectively. In this case, the guide bush 5 has large and small guide holes 6. Alternatively, two types of guide bushes 5 having a guide hole 6 having a large diameter and a guide hole 6 having a small diameter may be prepared. Drilling tools 7 having different diameters drill the second fixing holes 19 having large and small diameters. Further, as shown in FIG. 7, an anchor bolt 60 has distal end portions 56, 57, and 58 having different diameters and attached with an adhesive 59 or mechanically connected to an inner portion of a main body portion 55 having a hollow cylindrical shape.

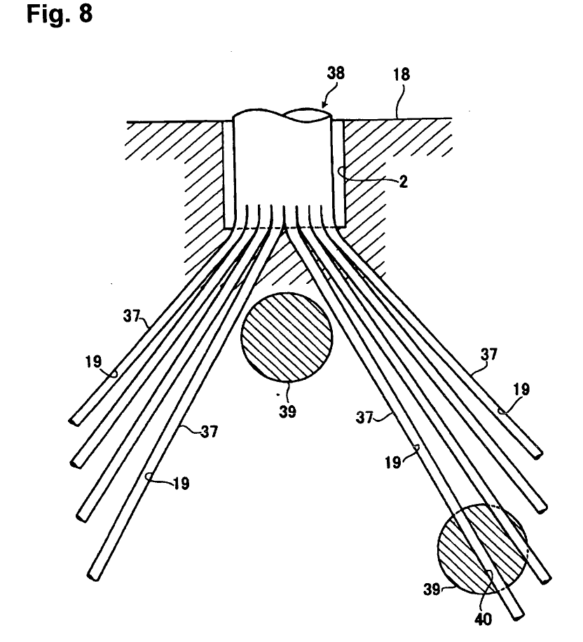

As shown in FIG. 8, an anchor bolt 36 is branched from a middle portion thereof into a plurality of distal end portions 37 in an octopus-leg shape. In this case, the guide bush 5 has a plurality of guide holes 6. Alternatively, a plurality of second fixing holes 19 is drilled with the second drilling tool 7 for multiple times. Further, when a reinforcing member 39 exists on a path, the second fixing hole 19 penetrating through the reinforcing member 39 is drilled, so that the distal end portion 37 of the anchor bolt 38 is inserted through a through hole 40 formed in the reinforcing member 39.

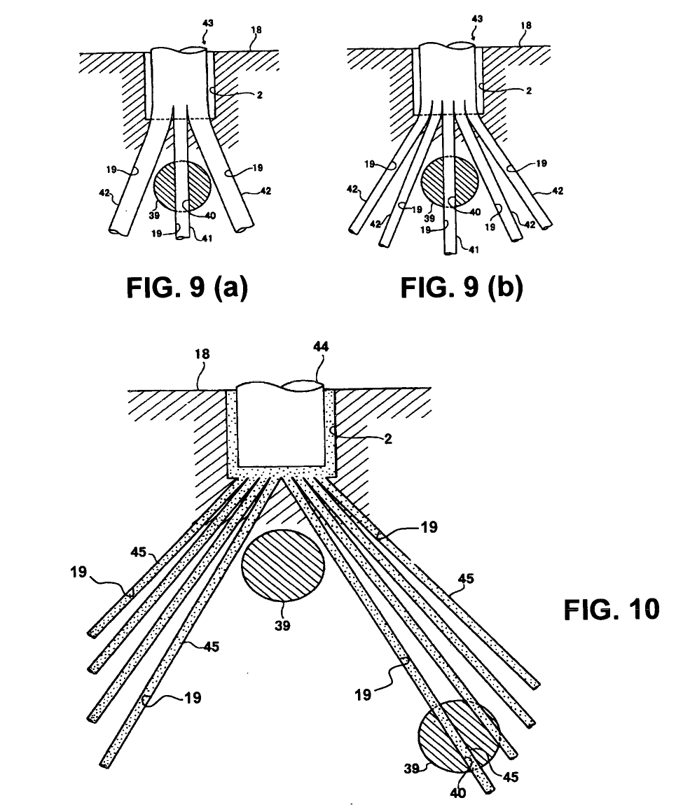

As shown in FIG. 9, an anchor bolt 43 is branched from a middle portion thereof into distal end portions 41 and 42. A center distal end portion among the distal end portions 41 and 42 is formed in a linear shape, and other distal end portions 42 are bent toward outside from the middle portion.

As shown in FIG. 10, a base end portion of an anchor bolt 44 is fixed in the first fixing hole 2, and a filling material 45 is filled in an outer circumferential portion of the first fixing hole 2 and the second fixing holes 19. In this case, when the reinforcing member 39 exists on a path, the second fixing hole 19 penetrating through the reinforcing member 39 is drilled, so that the filling material 45 is filled in the through hole 40 formed in the reinforcing member 39.

A method of fixing the anchor bolt in the first and second fixing holes will be explained next. In the method, the second fixing hole having a diameter same as that of the first fixing hole is drilled from the distal end portion of the fist fixing hole in an inclined state.

As shown in FIG. 11, first, a first drilling bit 62 attached to a distal end of a first drilling tool 61 is used to drill a first fixing hole 64 having a cylindrical shape in a fixing surface 63. At this time, when a reinforcing member 65 is installed inside at a dept known in advance, the first fixing hole 64 is drilled up to a depth smaller than that of the reinforcing member 65.

In the next step, as shown in FIG. 12, after the first drilling tool 61 is pulled out, a bar portion 66 having a cylindrical shape and remaining at a center portion of the first fixing hole is cut at a distal end portion of the first fixing hole 64 to be removed. Accordingly, the first fixing hole 64 having a cylindrical shape is formed in the fixing surface 63.

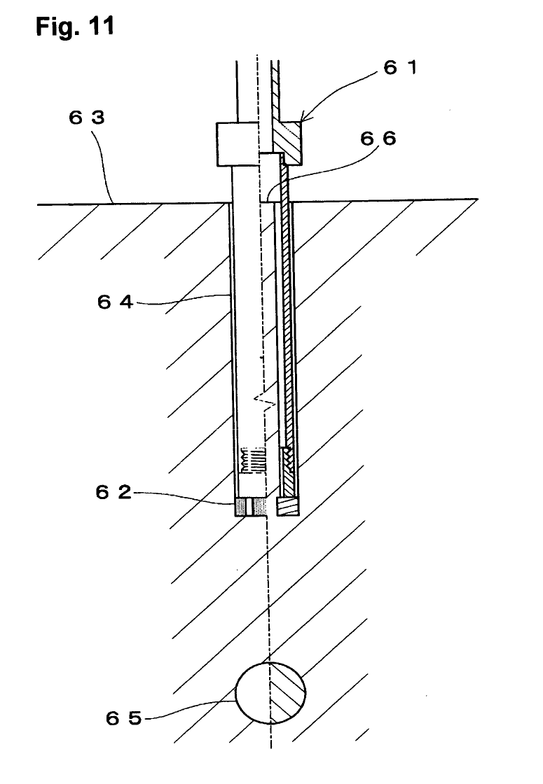

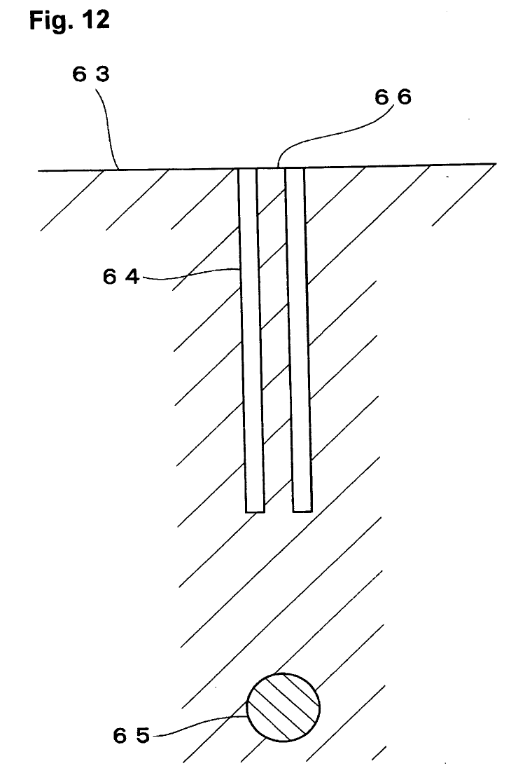

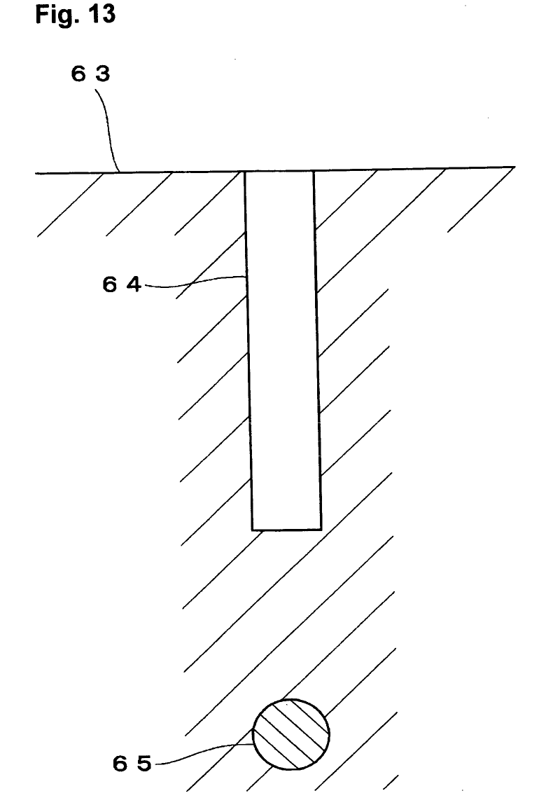

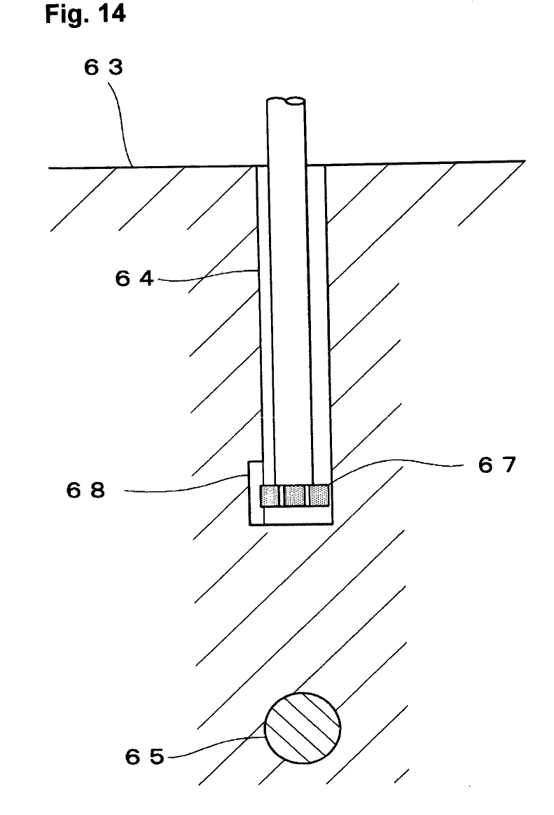

In the next step, as shown in FIG. 14, a drilling bit 67 is moved at the distal end portion of the first fixing hole 64, thereby forming a sidewall recess portion 68.

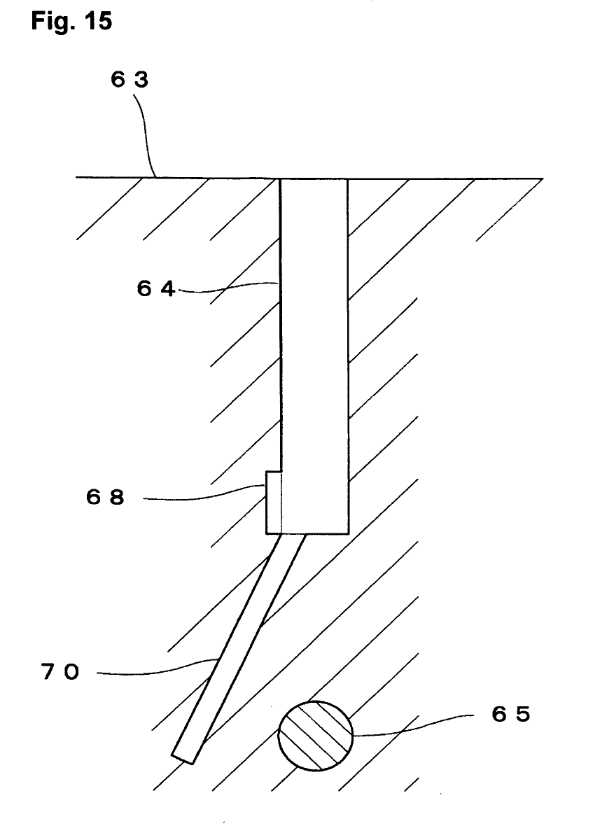

In the next step, as shown in FIG. 15, a lower hole 70 is drilled from the distal end portion of the first fixing hole 64 in an inclined state with a drilling bit having a diameter smaller than that of the first drilling bit 62.

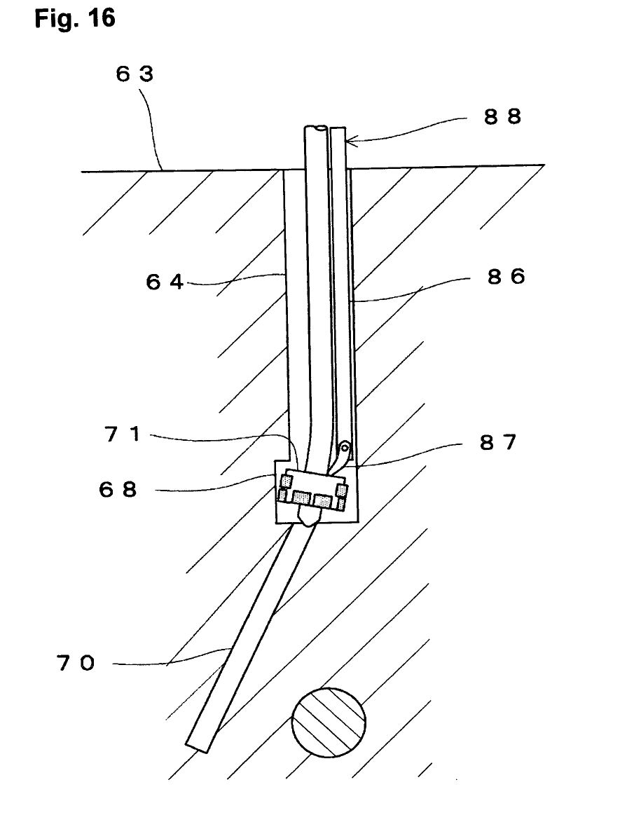

In the next step, as shown in FIG. 16, a second drilling bit 71 having a diameter same as that of the first drilling bit 62 is inserted into the first fixing hole 64. At the same time, a tool 88 is inserted into the first fixing hole 64. The tool 88 has a main body 86 having a bar shape and a claw portion 87 attached to a distal end of the main body 86 to be freely rotatable. With the tool 88, it is easy to insert a protruding guide portion 78 of the second drilling bit 71 into the lower hole 70.

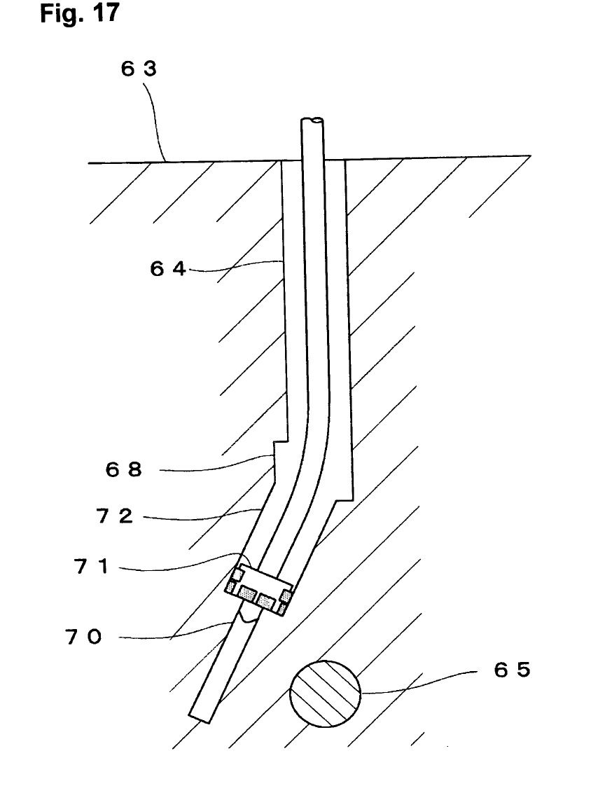

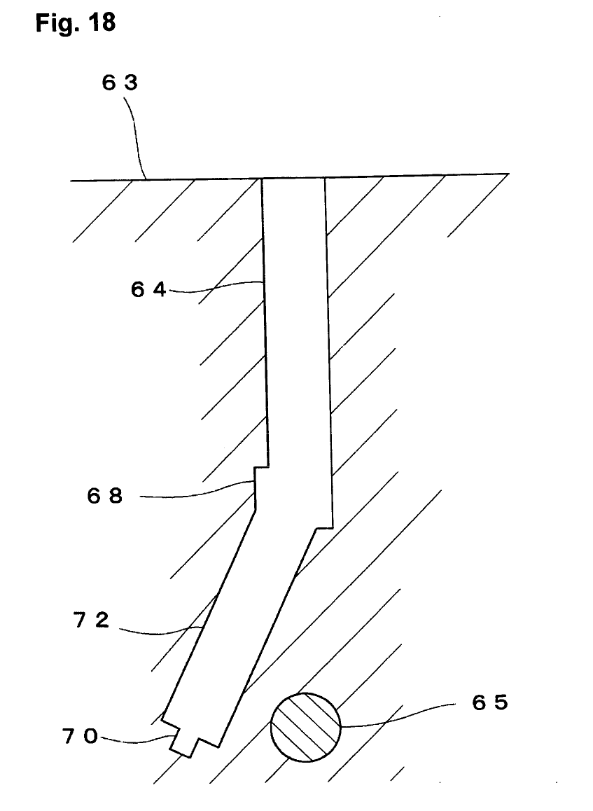

In the next step, as shown in FIG. 17, the second drilling bit 71 having a diameter same as that of the first drilling bit 62 is moved along the lower hole 70, thereby drilling a second fixing hole 72. Accordingly, as shown in FIG. 18, the second fixing hole 72 having a diameter same as that of the first fixing hole 64 is formed to extend from a distal end portion of the first fixing hole 64 in an inclined state.

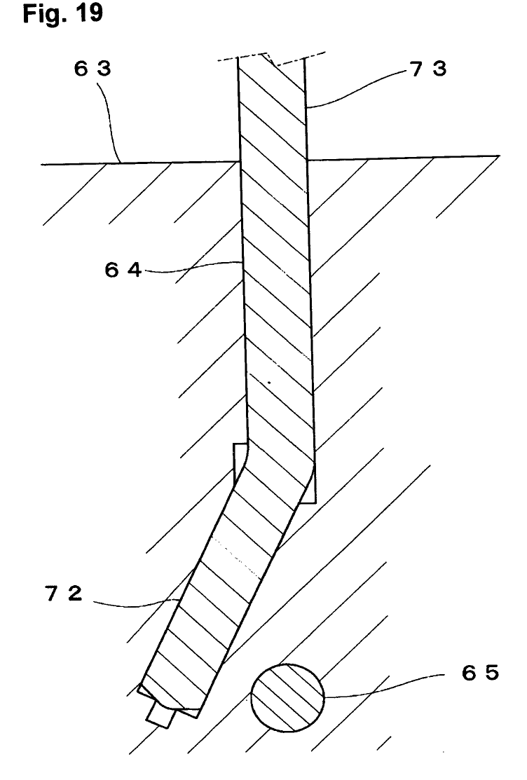

In the last step, as shown in FIG. 19, an anchor bolt 73 bent at a middle portion thereof is fixed to the first fixing hole 64 and the second fixing hole 72.

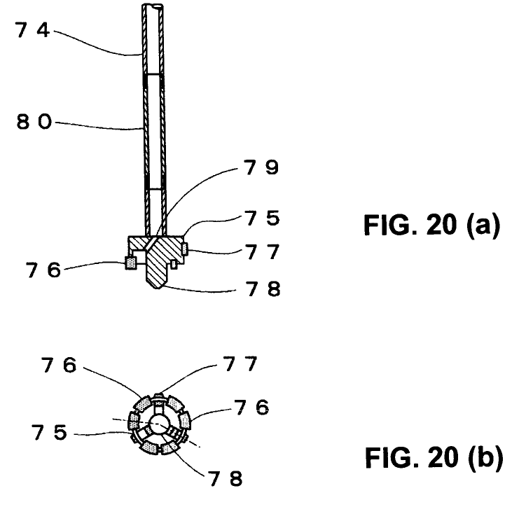

As shown in FIG. 20, the second drilling bit 71 is attached to a distal end of a boring bar 74 having flexibility and a cylindrical shape. Grinding stones 76 are attached to an outer circumferential end portion of a main body 75 having a cylindrical column shape. The protruding guide portion 78 having a sharp-pointed shape is formed at a center of a distal end of the main body 75. A through hole 79 communicating with the boring bar 74 is formed in the main body 75.

The boring bar 74 is provided with a bending portion 80 formed of an ultra-flexible alloy at a middle portion thereof. The boring bar 74 can be bent in various angles at the bending portion 80. Accordingly, it is possible to repeatedly bend the boring bar 74 without generating a permanent strain therein. The boring bar 74 may be formed of a normal alloy.

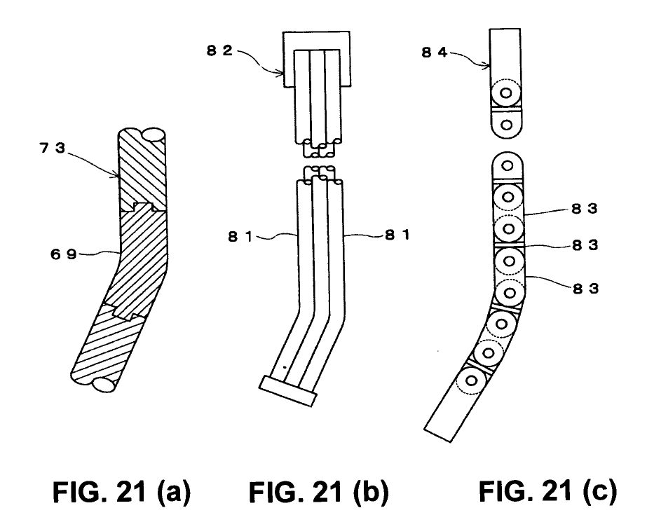

As shown in FIG. 21(a), the anchor bolt 73 has a bending portion 69 formed of a shape-memory ally at a middle portion thereof. Alternatively, as shown in FIG. 21(b), it is possible to use an anchor bolt 82 having a plurality of column bars 81 having a small diameter and bundled at both ends thereof. Further, as shown in FIG. 21(c), it is possible to use an anchor bolt 84 having a plurality of joints 83 connected to be freely bendable.

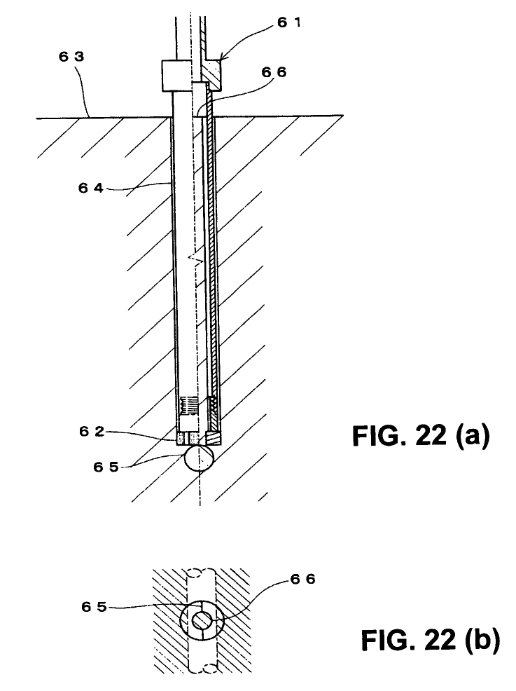

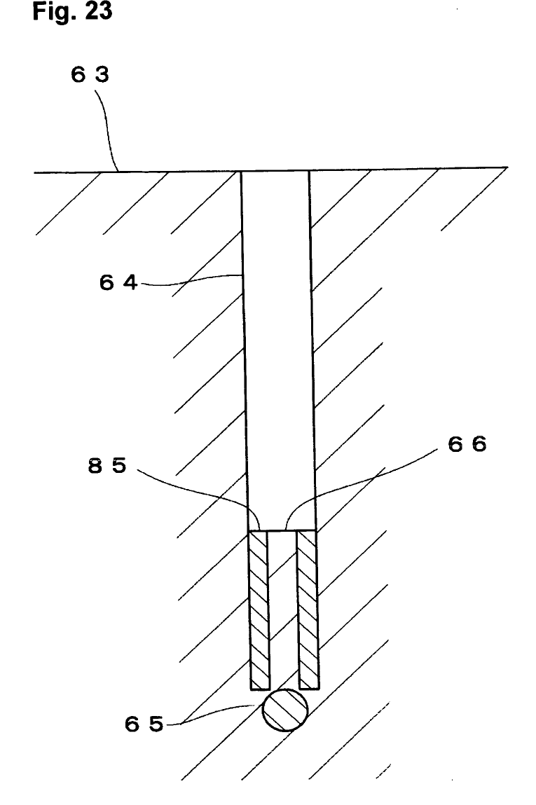

When the reinforcing member 65 is installed inside at an unknown dept, as shown in FIGS. 22(a) and 22(b), the first drilling tool 61 drills the first fixing hole 64 having a cylindrical shape until hitting against the reinforcing member 65 installed inside. Then, the bar portion 66 remaining at the center portion is cut and removed. Afterward, as shown in FIG. 23, cement or a filling material 85 is filled in a portion surrounding the bar portion 66 remaining to form the first fixing hole 64.

As described above, when the first fixing hole 64 is drilled until hitting against the reinforcing member 65 installed inside, as shown in FIG. 22(b), it is possible to determine an exact location of the reinforcing member 65 with a naked eye or a fiber scope. Accordingly, when the second fixing hole 72 is drilled, it is possible to precisely set an inclined direction or an inclined angle.

### INDUSTRIAL APPLICABILITY

According to the present invention, it is possible to fix an anchor bolt with sufficient strength without lowering strength even when a reinforcing member exists inside a fixing surface.

1. A method of installing an anchor bolt in a fixing surface, comprising the steps of:
drilling a first fixing hole for fixing the anchor bolt in the fixing surface; then,
drilling a second fixing hole from a distal end portion of the first fixing hole in an inclined state; and
fixing an anchor bolt bent at a middle portion thereof to the first fixing hole and the second fixing hole.

2. A method of installing an anchor bolt in a fixing surface, comprising the steps of:
drilling a first fixing hole for fixing the anchor bolt in the fixing surface;
drilling a plurality of second fixing holes from a distal end portion of the first fixing hole in an inclined state; and,
fixing an anchor bolt having a plurality of branched portions at a middle portion thereof to the first fixing hole and the second fixing holes.

3. The method of installing an anchor bolt according to claim 1, wherein said first fixing hole is drilled with a first drilling bit detachably attached to a distal end of a first drilling tool; then, the first drilling bit at the distal end of the first drilling tool is replaced with a guide bush; a second drilling tool is inserted through a guide hole formed in the guide bush in an inclined state; and lastly, the second fixing hole is drilled with a second drilling bit detachably attached to a distal end of the second drilling tool.

4. The method of installing an anchor bolt according to claim 2, wherein at least one of said plurality of the second fixing holes is drilled to penetrate through an existing reinforcing member installed inside the fixing surface.

5. The method of installing an anchor bolt according to any one of claim 2, wherein said plurality of the branched portions of the anchor bolt is formed of a shape-memory alloy so that a distal end portion of the anchor bolt can open and close according to a temperature change.

6. A method of drilling a fixing hole for fixing an anchor bolt in a fixing surface, comprising the steps of:
drilling a first fixing hole in the fixing surface; and
drilling a plurality of second fixing holes from a distal end portion of the first fixing hole in an inclined state.

7. The method of drilling a fixing hole for fixing an anchor bolt according to claim 6, wherein said first fixing hole is drilled with a first drilling bit detachably attached to a distal end of a first drilling tool; then, the first drilling bit at the distal end of the first drilling tool is replaced with a guide bush; a second drilling tool is inserted through a guide hole formed in the guide bush in an inclined state; and the second fixing holes are drilled with the second drilling bit detachably attached to a distal end of the second drilling tool.

8. The method of drilling a fixing hole for fixing an anchor bolt according to claim 6, wherein at least one of said plurality of the second fixing holes is drilled to penetrate through an existing reinforcing member installed inside the fixing surface.

9. A drilling device for drilling a fixing hole for fixing an anchor bolt in a fixing surface, comprising:
a first drilling tool;
a first drilling bit detachably attached to a distal end of the first drilling tool;
a guide bush detachably attached to the distal end of the first drilling tool;
a second drilling tool to be inserted through a guide hole formed in the guide bush in an inclined state; and
a second drilling bit detachably attached to a distal end of the second drilling tool.

10. The drilling device according to claim 9, wherein said second drilling bit includes a guide portion and a grinding stone on an outer circumference surface thereof, said guide portion having a height same as that of the grinding stone.

11. The method of installing an anchor bolt according to claim 2, wherein said first fixing hole is drilled with a first drilling bit detachably attached to a distal end of a first drilling tool; then, the first drilling bit at the distal end of the first drilling tool is replaced with a guide bush; a second drilling tool is inserted through a guide hole formed in the guide bush in an inclined state; and lastly, the second fixing hole is drilled with a second drilling bit detachably attached to a distal end of the second drilling tool.

12. An anchor bolt to be installed in a fixing surface, comprising:
a main portion extending in a first direction and having a distal end; and
an end portion extending from the distal end portion of the main portion in an inclined state relative to the first direction.

13. The anchor bolt according to claim 12, wherein said end portion includes a plurality of column bars bundled at both ends thereof.

14. The anchor bolt according to claim 12, wherein said end portion includes a first branch portion and a second branch portion each branched from the distal end portion of the main portion.

15. The anchor bolt according to claim 14, wherein at least one of said first branch portion and said second branch portion is formed of a shape-memory alloy.

16. The anchor bold according to claim 14, wherein at least one of said first branch portion and said second branch portion is connected to the main portion through a joint.

17. The anchor bolt according to claim 14, wherein said first branch portion has a first diameter, and said second branch has a second diameter different from the first diameter.
